(19) United States
(12) Patent Application Publication
(10) Pub. No.: US 2013/0015178 A1
(43) Pub. Date: Jan. 17, 2013

(54) HIGH FREQUENCY ELECTROMAGNETIC INDUCTION HEATING DEVICE AND METHOD FOR USING THE SAME TO HEAT SURFACE OF MOLD

(71) Applicant: Shu-Chen LIN, Taoyuan County (TW)

(72) Inventor: Shu-Chen LIN, Taoyuan County (TW)

(73) Assignee: Quanta Computer Inc., Taoyuan Shien (TW)

(21) Appl. No.: 13/340,144

(22) Filed: Dec. 29, 2011

(30) Foreign Application Priority Data
Jul. 13, 2011 (TW) 100124800

(51) Int. Cl. H05B 6/02; H05B 6/04; H05B 6/36

(52) U.S. Cl. 219/660; 219/672

(57) ABSTRACT

A high frequency electromagnetic induction heating device includes a power supply, a high frequency electromagnetic induction coil and an electromagnetic guide sleeve. The high frequency electromagnetic induction coil has two electrodes which are electrically connected with the power supply. The electromagnetic guide sleeve is disposed around the high frequency electromagnetic induction coil, and has an opening exposing the high frequency electromagnetic induction coil, wherein the opening faces towards a surface to be heated.

### RELATED APPLICATIONS

This application claims priority to Taiwan Application Serial Number 100124800, filed Jul. 13, 2011, which is herein incorporated by reference.

### BACKGROUND

1. Field of Invention

The present invention relates to a high frequency electromagnetic induction heating device and a method for using the same. More particularly, the present invention relates to a high frequency electromagnetic induction heating device and a method using the same for heating a mold core.

2. Description of Related Art

The steps of a conventional plastic injection molding method includes: filling plastic materials into a tube of a injection molding machine so as to heat and melt the plastic materials into a molten resin; sealing a mold; injecting the molten resin into a cavity of the mold; maintaining pressure in the injection molding machine; cooling the mold by liquid circulation; opening the mold; and taking out a product from the cavity of the mold.

During the injection molding manufacturing process, the mold temperature influences the molding cycle and the appearance quality of the plastic products, e.g., deformation, welded bone and brightness.

Therefore, a traditional mold warm machine or embedding electric bar is used to heat the injection mold. However, the traditional technique maintains the mold in the high temperature, thereby prolonging a cooling time of the plastic molding product and decreasing the production efficiency.

The known technology of the rapid heat cycle molding is directed to using high pressure vapor passing through a water channel within the mould core to heat the mold, and injecting the cooling water passing through the water channel to cool the mold after injecting the plastics into the cavity from the plastic injection molding machine. The disadvantage is that the heating time takes more than 30 seconds because the steel thermal efficiency influences the mould core's cooling and heating efficiency.

Therefore, it is important to develop a method and a device for heating the mold without the foregoing disadvantages.

### SUMMARY

It is therefore an objective of the present invention to provide a high frequency electromagnetic induction heating device and a method using the same.

In accordance with the foregoing and other objectives of the present invention, a high frequency electromagnetic induction heating device includes a power supply, a high frequency electromagnetic induction coil and an electromagnetic guide sleeve. The high frequency electromagnetic induction coil has two electrodes, which are electrically-connected with the power supply. The electromagnetic guide sleeve is disposed around the high frequency electromagnetic induction coil, and has an opening exposing the high frequency electromagnetic induction coil, wherein the opening faces towards a surface to be heated.

According another embodiment disclosed herein, the electromagnetic guide sleeve is an iron core electromagnetic guide sleeve.

According another embodiment disclosed herein, the iron core electromagnetic guide sleeve is made from an iron oxide magnet.

According another embodiment disclosed herein, the electromagnetic guide sleeve has two terminal ends to collectively define the opening of the electromagnetic guide sleeve, and each of the two terminal ends has an end surface disposed in parallel with the surface to be heated.

According another embodiment disclosed herein, the high frequency electromagnetic induction coil is a rectangular coil.

According another embodiment disclosed herein, the high frequency electromagnetic induction coil is a circular coil.

In accordance with the foregoing and other objectives of the present invention, a method of using the high frequency electromagnetic induction heating device to heat a mould core includes the steps of: providing a high frequency electromagnetic induction coil around which a electromagnetic guide sleeve is disposed, the electromagnetic guide sleeve having an opening exposing the high frequency electromagnetic induction coil; moving the high frequency electromagnetic induction coil close to a mould core surface and having the opening of the electromagnetic guide sleeve face towards the mould core surface; and supplying power to the high frequency electromagnetic induction coil to heat the mould core surface.

According to another embodiment disclosed herein, the method further includes the step of heating the mould core surface for about two seconds to about eight seconds.

According to another embodiment disclosed herein, the method further includes the step of arranging two terminal end surfaces of the electromagnetic guide sleeve to be in parallel with the mould core surface.

According to another embodiment disclosed herein, the high frequency electromagnetic induction coil is a rectangular coil or a circular coil.

Thus, the high frequency electromagnetic induction heating device disclosed herein not only shortens a heating time for the mould core surface but also gets a better average heating temperature and decreases the coil power consumption.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a top view of a high frequency electromagnetic induction heating device according to an embodiment of the present invention;

FIG. 2 illustrates a cross-sectional view of the high frequency electromagnetic induction heating device viewed across the cross-section line 2-2′ of FIG. 1;

FIG. 3 illustrates a top view of the high frequency electromagnetic induction heating device according to another embodiment of the present invention;

FIG. 4 illustrates a cross-sectional view of the high frequency electromagnetic induction heating device taken along the cross-section line 4-4′ of FIG. 3; and

FIG. 5 illustrates a flow chart for using the high frequency electromagnetic induction heating device to heat the mould core according an embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

The present invention uses the electromagnetic guide sleeve to serve as a coil carrier for guiding the electromagnetic field direction so as to guide most magnetic lines towards an iron core to be heated and to avoid the magnetic flux repelling contrast, thereby distributing the magnetic flux uniformly on the mould core surface and heating the mould core surface uniformly. In one embodiment, the iron core is made from an iron oxide magnet.

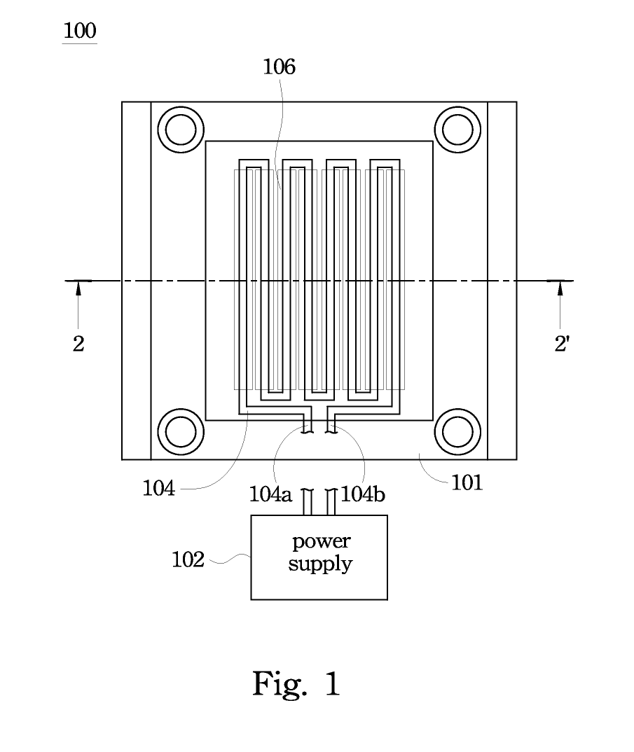

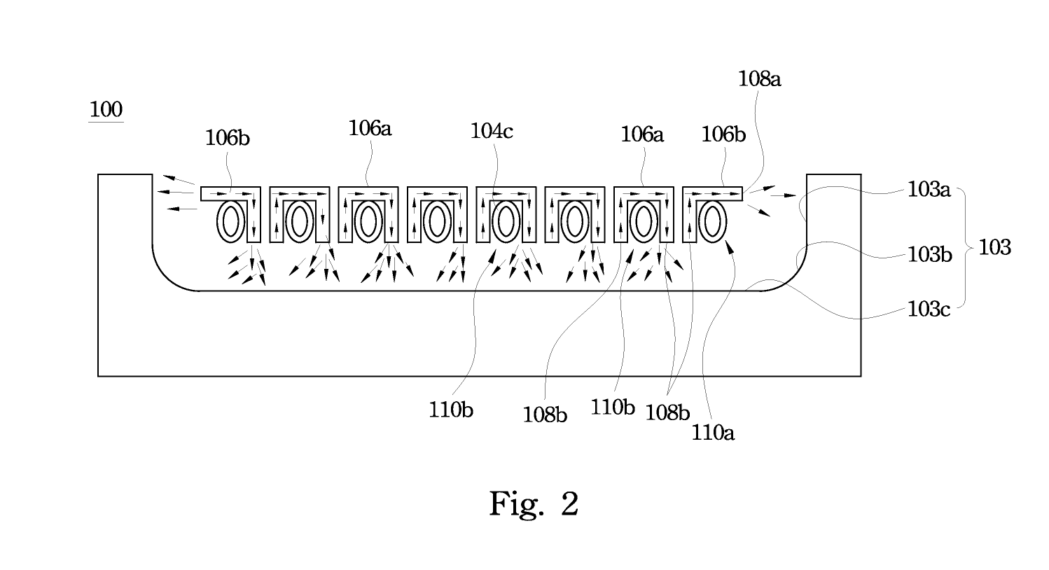

Referring to both FIG. 1 and FIG. 2, FIG. 1 shows a top view of a high frequency electromagnetic induction heating device 100 according to an embodiment of the present invention, and FIG. 2 shows a cross-sectional view of the high frequency electromagnetic induction heating device 100 taken along the 2-2′ cross-section line of FIG. 1. The high frequency electromagnetic induction heating device 100 is used to heat a mould core 101. The high frequency electromagnetic induction heating device 100 includes a high frequency power supply 102 and a high frequency electromagnetic induction coil 104. The two terminal electrodes 104a/104b of the coil 104 are electrically connected to the high frequency power supply 102. An electromagnetic guide sleeve 106 is used to cover the coil 104 of the high frequency electromagnetic induction heating device 100. The electromagnetic guide sleeve 106 is used to guide the electromagnetic field directions along desired directions, thereby avoiding hot spots or cold spots on the mould core surface caused by the approximate effect and the skin effect.

As shown in FIG. 2, each magnetic guide sleeve 106a/106b has two terminal ends to collectively define an opening 110a/110b, which exposes a coil inside thereof. The openings of the electromagnetic guide sleeve 106a/106b face towards the heat mould core surface for guiding the electromagnetic field direction. Because the surface 103 of the mould core 101 is not a flat plane, the openings of the electromagnetic guide sleeve 106a/106b are orientated towards the mould core surface 103. For example, the openings 110b of the electromagnetic guide sleeves 106a face towards a horizontal surface 103c of the mould core, but the openings 110a of the electromagnetic guide sleeve 106b face towards an arc surface 103b of the mould core.

As described above, each of the electromagnetic guide sleeves 106a/106b has two terminal ends, each of the two terminal ends has an end surface, to collectively define the opening 110a/110b. The end surfaces 108b of the terminal ends of the electromagnetic guide sleeve 106a all face towards the horizontal surface 103c of the mould core, and are generally arranged in parallel with the horizontal surface 103c. The electromagnetic guide sleeve 106b at the most outer position has its one end surface 108b of one terminal end facing towards and disposed in parallel with the horizontal surface 103c of the mould core, and its another end surface 108a of the other terminal end facing towards and disposed in parallel with the vertical surface 103a of the mould core. That is, each electromagnetic guide sleeve 106a/106b has its two end surfaces arranged generally in parallel with the mould core surface 103. With this regard, the electromagnetic field direction generated by the high frequency electromagnetic induction coil can be guided along desired directions (as illustrated by arrows in FIG. 2) so as to heat the mould core surface 103 uniformly.

The high frequency power supply 102 supplies an alternating current of which a frequency ranges from about 100 KHz to 300 MHz in order to heat the mould core surface 103. The shape of the coil 104 can be bent to form a desired pattern, e.g., a rectangular coil, according to a shape of a heat mould core surface to be heated. Generally speaking, an interval between adjacent wires 104c should be arranged equally so as to maintain a uniform electromagnetic field.

In this embodiment, the electromagnetic guide sleeve has an L-shaped or π-shaped cross-section, but the electromagnetic guide sleeve's cross-section is not limited to these two shapes. The electromagnetic guide sleeve cross-sections of other shapes, which are capable of covering an outer surface of the coil 104, can be used, e.g., an electromagnetic guide sleeve of a V-shaped or U-shaped cross-section.

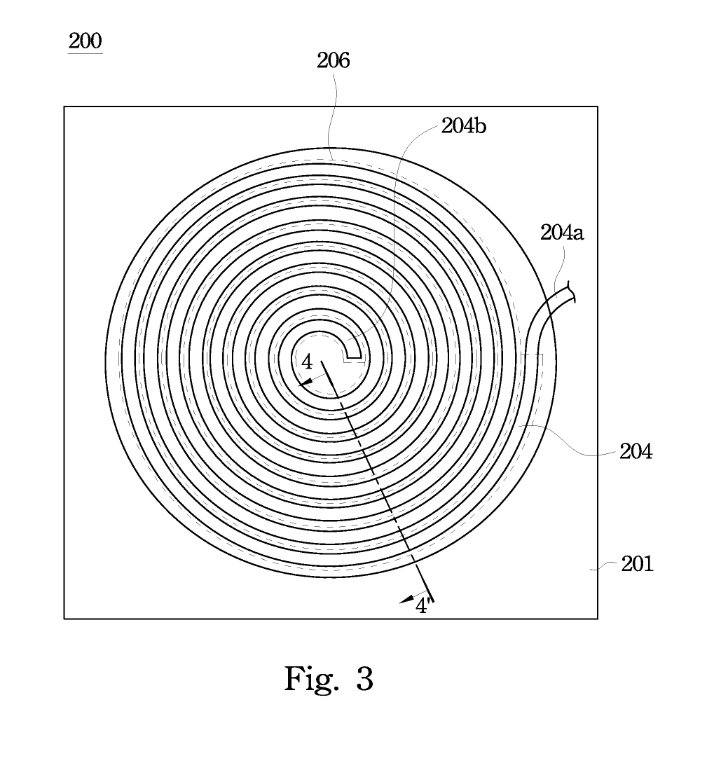

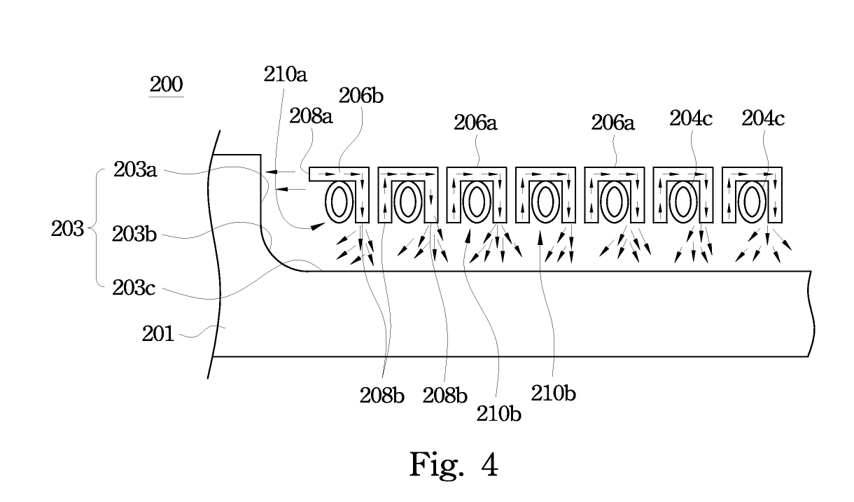

Referring to FIG. 3 and FIG. 4, FIG. 3 illustrates a top view of the high frequency electromagnetic induction heating device according to another embodiment of the present invention, and FIG. 4 illustrates a cross-sectional view of the high frequency electromagnetic induction heating device taken along the cross-section line 4-4′ of FIG. 3. The embodiment of FIG. 3 and FIG. 4 is different from the embodiment of FIG. 1 and FIG. 2 in using the electromagnetic guide sleeve to cover a high frequency electromagnetic induction coil of a different design.

The high frequency electromagnetic induction heating device 200 has a swirling-shaped coil 204. The coil 204 has its two opposite electrodes 204a/204b electrically connected to a high frequency power supply, e.g., a high frequency power supply 102 in FIG. 1. An electromagnetic guide sleeve 206 is used to cover the coil 204 of the high frequency electromagnetic induction heating device 200. The electromagnetic guide sleeve 206 is used to guide the electromagnetic field directions along desired directions, thereby avoiding hot spots or cold spots on the mould core surface caused by the approximate effect and the skin effect.

As shown in FIG. 4, each electromagnetic guide sleeve 206a/206b has two terminal ends to collectively define an opening 210a/210b, which exposes a coil thereinside. The openings 210a/210b of the electromagnetic guide sleeve 206a/206b face towards the heat mould core surface for guiding the electromagnetic field direction. Because the mould core surface 203 is not a flat plane, the openings 210a/210b of the electromagnetic guide sleeve 206a/206b are orientated towards the mould core surface 203. For example, the openings 210b of most electromagnetic guide sleeves 206a face towards a horizontal surface 203c of the mould core, but the opening 210a of the electromagnetic guide sleeve 206b face towards an arc surface 203b of the mould core.

As described above, each of the electromagnetic guide sleeves 206a/206b has two terminal ends, each of the two terminal ends has an end surface, to collectively define the opening 210a/210b. The end surfaces 208b of one terminal ends of the electromagnetic guide sleeve 106a all face towards the horizontal surface 203c of the mould core, and are arranged generally in parallel with the horizontal surface 203c. The electromagnetic guide sleeve 206b at the most outer position has its one end surface 208b of one terminal end facing towards and disposed in parallel with the horizontal surface 203c of the mould core, and its another end surface 208a of the other terminal end facing towards and disposed in parallel with the vertical surface 203a of the mould core. That is, each electromagnetic guide sleeve 206a/206b has its two end surfaces arranged generally in parallel with the mould core surface 203. With this regard, the electromagnetic field direction generated by the high frequency electromagnetic induction coil can be guided along desired directions (as illustrated by arrows in FIG. 4) so as to heat the mould core surface 203 uniformly.

The shape of the coil 204 can be bent to form a desired pattern, e.g., a circular coil, according to a heat mould core surface to be heated. Generally speaking, an interval between adjacent wires 204c should be arranged equally so as to maintain a uniform electromagnetic field.

In this embodiment, the electromagnetic guide sleeve has an L-shaped or π-shaped cross-section, but the electromagnetic guide sleeve's cross-section is not limited to these two shapes. The electromagnetic guide sleeve of other shaped cross-section, which is capable of covering the coil 204, can be used, e.g., an electromagnetic guide sleeve of V-shaped or U-shaped cross-section.

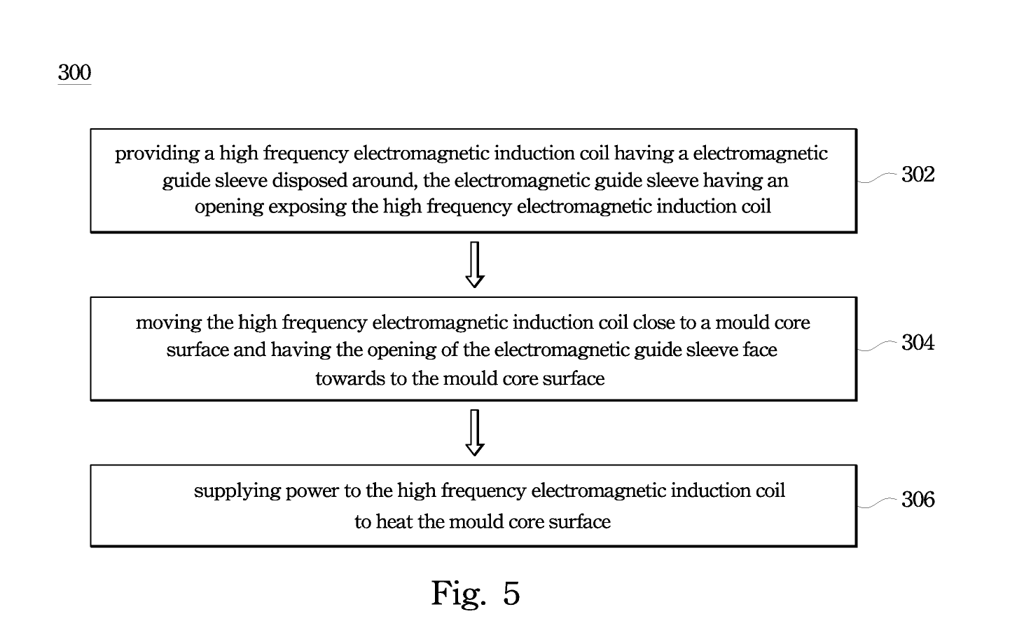

FIG. 5 illustrates a flow chart of a method 300 for using the high frequency electromagnetic induction heating device to heat the mould core according to an embodiment of the present invention. The step 302 is performed for providing a high frequency electromagnetic induction coil, e.g., the coil 104/204 from the above embodiments, which has an electromagnetic guide sleeve, e.g., the electromagnetic guide sleeve 106/206 from the above embodiments, with an opening, e.g., the opening 110a/110b/210a/210b from the above embodiments, is covered around the coil. The step 304 is performed for moving the high frequency electromagnetic induction coil close to the mould core surface to be heated, e.g., the mould core surface 103/203 from the above embodiments, and having the electromagnetic guide sleeve's opening face towards the mould core surface. The step 306 is performed for supplying power to the high frequency electromagnetic induction coil in order to heat the mould core surface.

By the experimental results, when optimal coil design (with the electromagnetic guide sleeve) is used to heat the mould core surface, heating the mould core surface from 80 up to 240 takes 2-8 seconds, and the temperature range is no more than ±5 in an average temperature of heating repeated tests.

When a conventional coil (without the electromagnetic guide sleeve) heats the same mould core surface, heating the mould core surface from 80 up to 240 takes 7˜10 seconds, and the temperature range is up to 30-40 in an average temperature of heating repeated tests.

In addition, the optimal coil design disclosed herein can decrease the power consumption. By the experimental results, the optimal coil design power consumption is 15 KW and the conventional coil power consumption is 18 KW (without the electromagnetic guide sleeve). The power consumption saving rate is about 20%.

According to the above-discussed embodiments, the high frequency electromagnetic induction heating device disclosed herein not only shortens a heating time for the mould core surface but also gets a better heating average temperature and decreases the coil power consumption.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A high frequency electromagnetic induction heating device, comprising:
a power supply;
a high frequency electromagnetic induction coil having two electrodes which are electrically connected with the power supply; and
an electromagnetic guide sleeve which is disposed around the high frequency electromagnetic induction coil and has an opening exposing the high frequency electromagnetic induction coil, wherein the opening faces towards a surface to be heated.

2. The high frequency electromagnetic induction heating device of claim 1, wherein the electromagnetic guide sleeve is an iron core electromagnetic guide sleeve.

3. The high frequency electromagnetic induction heating device of claim 2, wherein the iron core electromagnetic guide sleeve is made from an iron oxide magnet.

4. The high frequency electromagnetic induction heating device of claim 1, wherein the electromagnetic guide sleeve has two terminal ends to collectively define the opening of the electromagnetic guide sleeve, each of the two terminal ends having an end surface arranged in parallel with the surface to be heated.

5. The high frequency electromagnetic induction heating device of claim 1, wherein the high frequency electromagnetic induction coil is a rectangular coil.

6. The high frequency electromagnetic induction heating device of claim 1, wherein the high frequency electromagnetic induction coil is a circular coil.

7. A method of using a high frequency electromagnetic induction heating device to heat a mould core, the method comprising:
providing a high frequency electromagnetic induction coil around which a electromagnetic guide sleeve is disposed, the electromagnetic guide sleeve having an opening exposing the high frequency electromagnetic induction coil;
moving the high frequency electromagnetic induction coil close to a mould core surface, and having the opening of the electromagnetic guide sleeve face towards the mould core surface; and
supplying power to the high frequency electromagnetic induction coil to heat the mould core surface.

8. The method of claim 7, further comprising:
heating the mould core surface for about two seconds to about eight seconds.

9. The method of claim 7, further comprising:
arranging two terminal end surfaces of the electromagnetic guide sleeve to be in parallel with the mould core surface.

10. The method of claim 7, wherein the high frequency electromagnetic induction coil is a rectangular coil or a circular coil.
